(19) United States
(12) Patent Application Publication
(10) Pub. No.: US 2025/0151049 A1
(43) Pub. Date: May 8, 2025

(54) TECHNIQUES FOR SELECTING RESOURCES FOR SIDELINK CO-CHANNEL CO-EXISTENCE WITH MIXED NUMEROLOGIES

(71) Applicant: QUALCOMM Incorporated, San Diego, CA (US)

(72) Inventors: Sourjya DUTTA, Jersey City, NJ (US); Qing LI, PRINCETON JUNCTION, NJ (US)

(21) Appl. No.: 18/921,668

(22) Filed: Oct. 21, 2024

Related U.S. Application Data
(60) Provisional application No. 63/595,527, filed on Nov. 2, 2023.

(51) Int. Cl. H04W 72/1263; H04W 72/0446

(52) U.S. Cl. CPC H04W 72/1263; H04W 72/0446

(57) ABSTRACT

Methods, systems, and devices for wireless communications are described. A user equipment (UE) may perform a first resource selection associated with a first resource selection window to select first transmission resources from a first set of available transmission resources for transmitting a first set of protocol data units (PDUs) in accordance with a first radio access technology (RAT), each transmission resource of the first set of available transmission resources being aligned with a beginning of a respective subframe for a second RAT. The UE may determine a second set of available transmission resources for transmitting a second set of PDUs in accordance with a second RAT, each transmission resource of the second set of available transmission resources occurring in a latter portion of a respective subframe for the second RAT and being located with respect to a respective first transmission resource of the first transmission resources.

### CROSS REFERENCE

The present application for patent claims the benefit of U.S. Provisional Patent Application No. 63/595,527 by DUTTA et al., entitled “TECHNIQUES FOR SELECTING RESOURCES FOR SIDELINK CO-CHANNEL CO-EXISTENCE WITH MIXED NUMEROLOGIES,” filed Nov. 2, 2023, assigned to the assignee hereof, and expressly incorporated by reference herein

### FIELD OF TECHNOLOGY

The following relates to wireless communications, including techniques for selecting resources for sidelink co-channel co-existence with mixed numerologies.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for selecting resources for sidelink co-channel co-existence with mixed numerologies. Generally, the techniques described herein may enable a user equipment (UE) to select resources for multiple sidelink transmissions associated with a first radio access technology (RAT) in a first slot of a pair of slots of the first RAT that overlap with a subframe of a second RAT, and optionally a second slot of the pair of slots of the first RAT that overlap with a subframe of a second RAT, where the first RAT is associated with a higher sub-carrier spacing (SCS) than the second RAT. For example, the UE may determine a first set of available transmission resources, where each transmission resource of the first set of available transmission resources is aligned with a beginning of a respective subframe for sidelink communications via the second RAT. That is, a subframe for sidelink communications via the second RAT may overlap with a first slot and a second slot for the first RAT, where the second slot is preceded by the first slot. As such, the first set of available transmission resources may correspond to multiple first slots over a set of subframes of the second RAT. Thus, the UE may perform first resource selection associated with a first resource selection window to select one or more transmission resources from the first set of transmission resources for transmitting a first set of protocol data units (PDUs) (e.g., one or more first PDUs) via a first sidelink connection in accordance with the first RAT.

Additionally, the UE may determine a second set of available transmission resources, where the second set of available transmission resources is based on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof. Thus, the UE may perform second resources selection to select one or more second transmission resources from the second set of available transmission resources for transmitting a second set of PDUs (e.g., one or more second PDUs) via the first sidelink connection in accordance with the first RAT.

A method for wireless communications by a UE is described. The method may include performing first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT, determining a second set of available transmission resources for transmitting a second set of PDUs via the first sidelink connection in accordance with the first RAT based on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof, and performing second resource selection to select one or more second transmission resources from the second set of available transmission resources for transmitting the second set of PDUs via the first sidelink connection in accordance with the first RAT.

A UE for wireless communications is described. The UE may include one or more memories storing processor executable code, and one or more processors coupled with the one or more memories. The one or more processors may individually or collectively operable to execute the code to cause the UE to perform first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT, determine a second set of available transmission resources for transmitting a second set of PDUs via the first sidelink connection in accordance with the first RAT based on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof, and perform second resource selection to select one or more second transmission resources from the second set of available transmission resources for transmitting the second set of PDUs via the first sidelink connection in accordance with the first RAT.

Another UE for wireless communications is described. The UE may include means for performing first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT, means for determining a second set of available transmission resources for transmitting a second set of PDUs via the first sidelink connection in accordance with the first RAT based on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof, and means for performing second resource selection to select one or more second transmission resources from the second set of available transmission resources for transmitting the second set of PDUs via the first sidelink connection in accordance with the first RAT.

A non-transitory computer-readable medium storing code for wireless communications is described. The code may include instructions executable by a processor to perform first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT, determine a second set of available transmission resources for transmitting a second set of PDUs via the first sidelink connection in accordance with the first RAT based on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof, and perform second resource selection to select one or more second transmission resources from the second set of available transmission resources for transmitting the second set of PDUs via the first sidelink connection in accordance with the first RAT.

In some examples of the method, UEs, and non-transitory computer-readable medium described herein, determining the second set of available transmission resources may include operations, features, means, or instructions for determining a first subset of transmission resources from the third set of transmission resources based on each transmission resource of the first subset of transmission resources occurring in a respective slot that aligns with a beginning of a respective subframe for the second RAT and determining a second subset of transmission resources from the third set of transmission resources based on each transmission resource of the second subset of transmission resources being located with respect to a respective first transmission resource of the one or more first transmission resources, where the one or more second transmission resources may be selected from the second subset of transmission resources based on a percentage of transmission resources in the first subset of transmission resources being less than a threshold percentage of resources that may be available in the third set of transmission resources.

Some examples of the method, UEs, and non-transitory computer-readable medium described herein may further include operations, features, means, or instructions for receiving, from a lower layer, an indication of the third set of transmission resources and an indication of physical slot indices associated with each transmission resource of the third set of transmission resources.

Some examples of the method, UEs, and non-transitory computer-readable medium described herein may further include operations, features, means, or instructions for determining a starting slot of the second resource selection window based on a starting transmission resource of the third set of transmission resources and the indicated physical slot indices and determining an end slot of the second resource selection window based on an ending transmission resource of the third set of transmission resources and the indicated physical slot indices.

In some examples of the method, UEs, and non-transitory computer-readable medium described herein, the indication further includes an indication of a starting slot of the second resource selection window and an ending slot of the second resource selection window.

Some examples of the method, UEs, and non-transitory computer-readable medium described herein may further include operations, features, means, or instructions for transmitting, via the first sidelink connection, the first set of PDUs via the one or more first transmission resources and the second set of PDUs via the one or more second transmission resources.

In some examples of the method, UEs, and non-transitory computer-readable medium described herein, a first transmission resource of the one or more first transmission resources corresponds to a first slot for the first RAT that overlaps with a subframe for the second RAT and a second transmission resource of the one or more second transmission resources corresponds to a second slot for the first RAT that overlaps with the latter portion of the subframe and the method, apparatuses, and non-transitory computer-readable medium may include further operations, features, means, or instructions for canceling transmission of the second set of PDUs via the second slot based on canceling transmission of the first set of PDUs via the first slot.

Some examples of the method, UEs, and non-transitory computer-readable medium described herein may further include operations, features, means, or instructions for receiving a cancelation notification indicating the first transmission resource associated and indicating the first slot associated with the first transmission resource and canceling the transmission of the first set of PDUs via the first slot based on receiving the cancelation notification.

Some examples of the method, UEs, and non-transitory computer-readable medium described herein may further include operations, features, means, or instructions for performing resource re-selection to select an additional second transmission resource of the one or more second transmission resources for transmitting the second set of PDUs via the first sidelink connection in accordance with the first RAT based on canceling transmission of the second set of PDUs via the second transmission resource of the one or more second transmission resources.

In some examples of the method, UEs, and non-transitory computer-readable medium described herein, the resource re-selection may be performed based on a threshold duration between the second transmission resource and reception of a cancelation notification.

In some examples of the method, UEs, and non-transitory computer-readable medium described herein, a duration between a first transmission resource of the one or more first transmission resources and an additional transmission resource of the one or more first transmission resources satisfies a threshold duration, the threshold duration associated with reception of feedback corresponding to transmission of the first set of PDUs via the first transmission resource.

In some examples of the method, UEs, and non-transitory computer-readable medium described herein, the second set of PDUs may be associated with a same priority or a lower priority as the first set of PDUs, may be associated with a same cast-type as the first set of PDUs, may be associated with a same destination identifier as the first set of PDUs, or any combination thereof.

In some examples of the method, UEs, and non-transitory computer-readable medium described herein, the first RAT may be a New Radio (NR) RAT and the second RAT may be Long Term Evolution (LTE) RAT.

In some examples of the method, UEs, and non-transitory computer-readable medium described herein, a SCS of the first RAT may be 30 kilohertz (kHz) and a SCS of the second RAT may be 15 kHz.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports techniques for selecting resources for sidelink co-channel co-existence with mixed numerologies in accordance with one or more aspects of the present disclosure.

FIG. 2 shows an example of a wireless communications system that supports techniques for selecting resources for sidelink co-channel co-existence with mixed numerologies in accordance with one or more aspects of the present disclosure.

FIG. 3 shows an example of a resource selection scheme that supports techniques for selecting resources for sidelink co-channel co-existence with mixed numerologies in accordance with one or more aspects of the present disclosure.

FIG. 4 shows an example of a process flow that supports techniques for selecting resources for sidelink co-channel co-existence with mixed numerologies in accordance with one or more aspects of the present disclosure.

FIGS. 5 and 6 show block diagrams of devices that support techniques for selecting resources for sidelink co-channel co-existence with mixed numerologies in accordance with one or more aspects of the present disclosure.

FIG. 7 shows a block diagram of a communications manager that supports techniques for selecting resources for sidelink co-channel co-existence with mixed numerologies in accordance with one or more aspects of the present disclosure.

FIG. 8 shows a diagram of a system including a device that supports techniques for selecting resources for sidelink co-channel co-existence with mixed numerologies in accordance with one or more aspects of the present disclosure.

FIGS. 9 through 11 show flowcharts illustrating methods that support techniques for selecting resources for sidelink co-channel co-existence with mixed numerologies in accordance with one or more aspects of the present disclosure.

### DETAILED DESCRIPTION

In some sidelink communications systems, user equipment (UEs) may support multiple radio access technologies (RATs), such as New Radio (NR) and Long Term Evolution (LTE). Thus, in some cases, both NR sidelink transmissions and LTE sidelink transmissions may be associated with a same frequency channel in the sidelink communications systems (e.g., may co-exist in the sidelink communications systems). Additionally, each type of sidelink channel (e.g., NR or LTE) may support a different sub-carrier spacing (SCS). For example, the NR sidelink channel may be associated with an SCS of 30 kilohertz (kHz) and the LTE sidelink channel may be associated with an SCS of 15 kHz, such that a single LTE sidelink subframe (or slot) may overlap with two NR sidelink slots. In other words, an NR sidelink transmission via an NR sidelink slot may overlap with an LTE sidelink reception during part, or half, of an LTE sidelink subframe. However, in some cases, the NR sidelink slot may overlap with a second half of the LTE sidelink subframe and, in such cases, the NR sidelink transmission may degrade reception of the LTE sidelink over the second half of the LTE sidelink subframe. That is, the LTE sidelink subframe may include one or more symbols at a beginning of the LTE sidelink subframe that are used by an LTE UE to train an automatic gain control (AGC) in an amplifier at a receiver of the LTE UE. As such, the LTE UE may train the AGC based on a first power associated with the LTE sidelink reception. However, the NR sidelink transmission during the second half of the LTE sidelink subframe may cause an increase in power at the AGC, such that the training of the AGC is no longer accurate, resulting in signal corruption of the LTE sidelink reception.

As such, an NR UE may determine to transmit an NR sidelink transmission during a first half of an LTE sidelink subframe, such that the LTE UE may train the AGC in a manner that accounts for both an LTE sidelink reception during the LTE subframe and an NR sidelink transmission during the first half of the LTE sidelink subframe. In other words, an LTE sidelink subframe may overlap with two NR sidelink slots, such that the NR UE may perform an NR sidelink transmission in a first NR sidelink slot of the two NR sidelink slots. However, performing NR sidelink transmissions in first overlapping NR slots may result in inefficient resource utilization.

Accordingly, techniques described herein may enable a UE to select both a first NR sidelink slot and a second NR sidelink slot overlapping with an LTE sidelink subframe for one or more NR sidelink transmissions. For example, the UE may determine to transmit a first set of NR protocol data unit (PDUs) during a first resource selection window and a second set of NR PDUs during a second resource selection window, where the second resource selection window at least partially overlaps with the first resource selection window. A set of NR PDUs may refer to one or more NR PDUs. Additionally, the first resource selection window and the second resource selection window may include NR slots that overlap with a set of LTE sidelink subframes. As such, a PHY layer at the UE may perform first resource selection associated with the first resource selection window to select one or more first transmission resources from a first set of available transmission resources for transmitting the first set of NR PDUs via a first sidelink connection in accordance with a first RAT, where the first candidate resource set includes candidate resources that correspond to first NR sidelink slots overlapping with an LTE sidelink subframe. In such cases, the first RAT may be associated with a higher SCS than the second RAT.

Additionally, a MAC layer at the UE may receive an indication of a candidate resource set associated with the first resource selection window at least partially overlapping with the second resource selection window and the UE may identify a second set of candidate resources from the candidate resource set. The second set of candidate resources may include a first subset of candidate resources, where the first subset of candidate resources includes candidate resources that correspond to first NR sidelink slots overlapping with an LTE sidelink subframe, and a second subset of candidate resources, where the second subset of candidate resources includes candidate resources that correspond to second NR sidelink slots overlapping with an LTE sidelink subframe that are preceded by first NR sidelink slots corresponding to the one or more first transmission resources. As such, the PHY layer may select one or more second transmission resources, corresponding to one or more second NR sidelink slots, from the second set of candidate resources to transmit the second set of NR PDUs.

Aspects of the disclosure are initially described in the context of wireless communications systems. Aspects of the disclosure are then described in the context of a resource selection scheme and a process flow. Aspects of the disclosure are further illustrated by and described with reference to apparatus diagrams, system diagrams, and flowcharts that relate to techniques for selecting resources for sidelink co-channel co-existence with mixed numerologies.

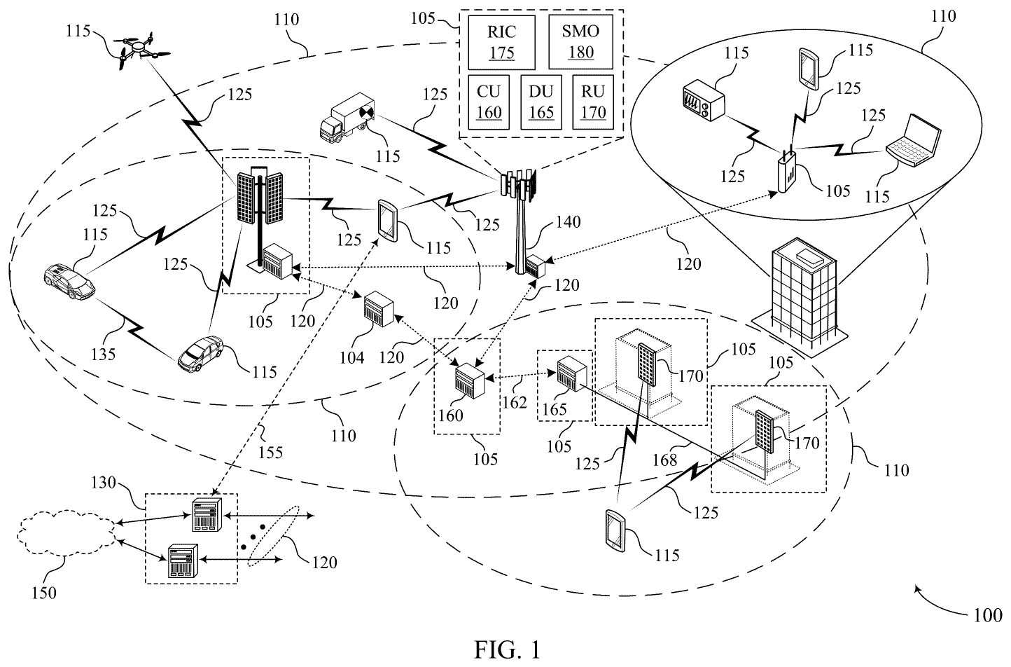

FIG. 1 shows an example of a wireless communications system 100 that supports techniques for selecting resources for sidelink co-channel co-existence with mixed numerologies in accordance with one or more aspects of the present disclosure. The wireless communications system 100 may include one or more network entities 105, one or more UEs 115, and a core network 130. In some examples, the wireless communications system 100 may be an LTE network, an LTE-Advanced (LTE-A) network, an LTE-A Pro network, a NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for selecting resources for sidelink co-channel co-existence with mixed numerologies as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, the wireless communications system 100 may support techniques that enable a UE 115 to select both a first NR sidelink slot and a second NR sidelink slot overlapping with an LTE sidelink subframe for one or more NR sidelink transmissions. For example, the UE 115 may determine to transmit a first set of NR PDUs during a first resource selection window and a second set of NR PDUs during a second resource selection window, where the second resource selection window at least partially overlaps with the first resource selection window. Additionally, the first resource selection window and the second resource selection window may include NR slots that overlap with a set of LTE sidelink subframes. As such, a PHY layer at the UE 115 may perform first resource selection associated with the first resource selection window to select one or more first transmission resources from a first set of available transmission resources for transmitting the first NR PDU via a first sidelink connection in accordance with a first RAT, where the first candidate resource set includes candidate resources that correspond to first NR sidelink slots overlapping with an LTE sidelink subframe. In such cases, the first RAT may be associated with a higher SCS than the second RAT.

Additionally, a MAC layer at the UE 115 may transmit, to the PHY layer, an indication of a candidate resource set associated with the first resource selection window at least partially overlapping with the second resource selection window and the PHY layer may identify a second set of candidate resources from the candidate resource set. The second set of candidate resources may include a first subset of candidate resources, where the first subset of candidate resources includes candidate resources that correspond to first NR sidelink slots overlapping with an LTE sidelink subframe, and a second subset of candidate resources, where the second subset of candidate resources includes candidate resources that correspond to second NR sidelink slots overlapping with an LTE sidelink subframe that are preceded by first NR sidelink slots corresponding to the one or more first transmission resources. As such, the PHY layer may select one or more second transmission resources, corresponding to one or more second NR sidelink slots, from the second set of candidate resources to transmit the second set of NR PDUs.

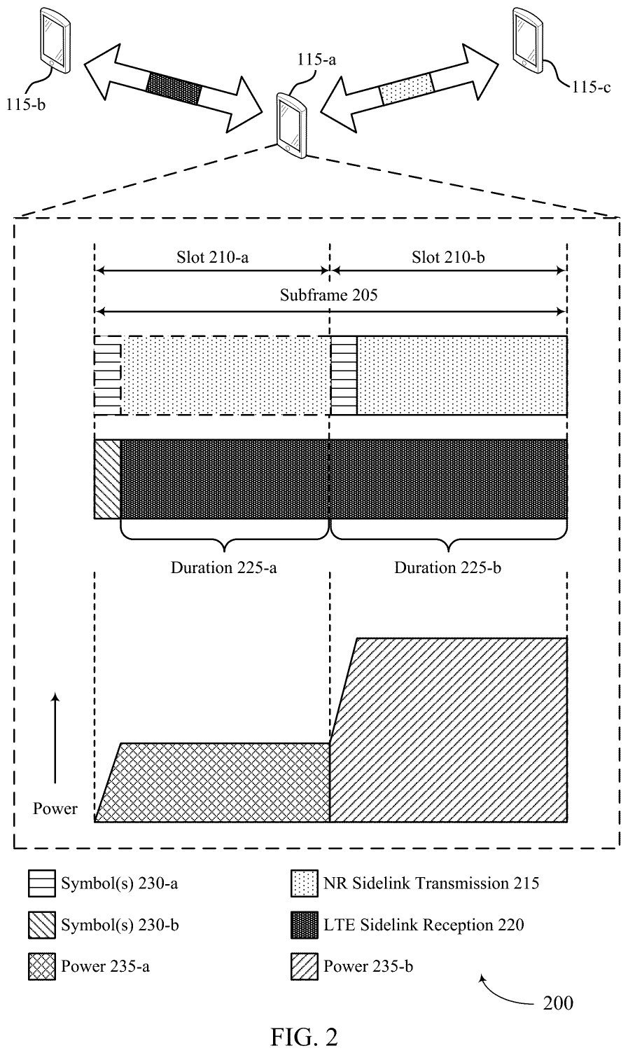

FIG. 2 shows an example of a wireless communications system 200 that supports techniques for selecting resources for sidelink co-channel co-existence with mixed numerologies in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a, a UE 115-b, and a UE 115-c) and one or more network entities 105, which may be examples of the corresponding devices as described herein.

In some sidelink communications systems, such as the wireless communications system 200, a UE 115, such as the UE 115-a (e.g., and optionally the UE 115-b and the UE 115-c) may support multiple RATs, such as NR and LTE. Thus, in some cases, both NR sidelink transmissions 215 (e.g., or receptions) and LTE sidelink receptions 220 (e.g., or transmissions) may be associated with a same frequency channel (e.g., shared channel) in the wireless communications system 200 (e.g., co-channel co-existence). Additionally, each type of communication (e.g., NR or LTE) may support a different SCS (e.g., mixed numerologies). For example, the NR sidelink transmissions may be associated with an SCS of 30 kHz (e.g., or 15 kHz) and the LTE sidelink transmissions may be associated with an SCS of 15 kHz, such that a single LTE sidelink subframe 205 (e.g., or slot) may overlap with multiple NR sidelink slots 210, such as a slot 210-a and a slot 210-b. In other words, an NR sidelink transmission 215 via an NR sidelink slot 210 may overlap with an LTE sidelink reception 220 during part, or half, of the LTE sidelink subframe 205. However, in some cases, the UE 115-b may determine not to transmit an NR sidelink transmission 215 during an NR sidelink slot 210, such as the NR sidelink slot 210-a, that overlaps with a first half of the LTE subframe 205 but may determine to transmit an NR sidelink transmission 215 during an NR sidelink slot 210, such as the NR sidelink slot 210-b, that overlaps with a second half of the LTE sidelink subframe 205, such as during a duration 225-b. In such cases, the NR sidelink transmission 215 during the slot 210-b may degrade the NR sidelink reception 220 during the duration 225-b (e.g., the second half of the LTE sidelink subframe 205).

That is, the LTE sidelink subframe 205 may include one or more symbols 230-b (e.g., OFDM symbols) at a beginning of the LTE sidelink subframe 205 that are used by the UE 115-b to train a first AGC (e.g., set a gain) in a first amplifier at a receiver of the UE 115-b (e.g., associated with the LTE sidelink reception 220). Similarly, the NR sidelink slot 210-b may include one or more symbols 230-a at a beginning of the NR sidelink slot 210-b that are used by the UE 115-c to train a second AGC in a second amplifier at a transmitter of the UE 115-c (e.g., associated with the NR sidelink slot 210-b).

In such cases, the UE 115-b may train the first AGC based on a power 235-a (e.g., received power) associated with the LTE sidelink reception 220 during a duration 225-a (e.g., without an NR sidelink transmission 215). However, the NR sidelink transmission 215 during the duration 225-b may cause an increase in power 235 at the first AGC, resulting in a power 235-b experienced by the first AGC during the duration 225-b, such that the training of the first AGC is no longer accurate, resulting in signal corruption of the LTE sidelink reception 220. In other words, if the power 235 (e.g., received power) changes during the LTE sidelink reception 220 (e.g., due to the NR sidelink transmission 215 changing a received power level during a latter half of the LTE sidelink subframe 205), gain associated with the first AGC at the receiver may be incorrect following the change and performance may be degraded at the UE 115-a. Additionally, or alternatively, the NR sidelink transmission 215 may cause interference (e.g., in-band emissions) to the LTE sidelink reception 220.

In some implementations (e.g., for NR sidelink transmissions with 15 or 30 KHz SCSs), the UE 115-a (e.g., NR sidelink UE 115-a) may avoid selecting resources for NR sidelink transmissions 215 (e.g., PSSCH and physical sidelink control channel (PSCCH) transmissions) where corresponding feedback (e.g., physical sidelink feedback channel (PSFCH)) transmission occasions overlap with an LTE subframe 205 (e.g., an LTE sidelink reservation in a time domain).

Additionally, or alternatively (e.g., to support different NR and LTE numerologies over a shared channel), the UE 115-a may determine to transmit (and transmit) NR sidelink transmissions 215 via multiple (e.g., a number of) NR slots 210 that fully overlap with an LTE subframe 205. In other words, the UE 115-a may determine to transmit a first NR sidelink transmission 215 via the slot 210-a and a second NR sidelink transmission 215 via the slot 210-b, where the NR slot 210-a and the NR slot 210-b are considered paired NR slots 210 and overlap with the LTE subframe 205. However, to enable the UE 115-b to select a correct AGC setting for the LTE subframe 205 during the symbols 230-b (e.g., AGC symbols), an NR transmitter at the UE 115-a transmitting the NR transmissions 215 (e.g., physical sidelink shared channel (PSSCH)) over the paired NR slots 210 may need to transmit at similar or equal power levels over the paired NR slots 210, such that power 235 (e.g., received power) associated with LTE sidelink reception 220 does not change over the LTE subframe 205. In other words, a power level associated with the first NR sidelink transmission 215 via the slot 210-a may need to be within a threshold of a power level associated with the second NR sidelink transmission 215 via the slot 210-b, thus increasing complexity.

In some other implementations (e.g., not depicted), the UE 115-a may determine to transmit (and transmit) NR sidelink transmissions 215 only via NR slots 210-a (e.g., only in a first NR slot 210-a that it time-aligned with a beginning of an LTE subframe 205, but not in a second NR slots 210-b). In such cases, a starting symbol 230 of the NR slot 210-a may be time-aligned (aligned in a time domain) with a first symbol 230 of the LTE subframe 205. In other words, the UE 115-a may transmit NR sidelink transmissions 215 via NR slots 210-a that overlap with first halves of LTE subframes 205 (e.g., during a duration 225-a) and may refrain from transmitting NR sidelink transmissions 215 via NR slots 210-b that overlap with second halves of LTE subframes 205 (e.g., during a duration 225-b). Doing so may enable the UE 115-b to train the first AGC to account for an LTE sidelink reception 220 (e.g., or transmission) and an NR sidelink transmission 215 (e.g., or reception) during an NR slot 210-a. However, only transmitting NR sidelink transmissions 215 during NR slots 210-a may result in inefficient resource utilization and reduce (e.g., cut in half) an achievable rate associated with the NR sidelink transmissions 215.

Accordingly, techniques described herein may enable a MAC layer at a UE 115, such as the UE 115-a, to perform resource selection for NR sidelink transmissions 215 (e.g., or receptions) and LTE sidelink receptions 220 (e.g., or transmissions), where the NR sidelink transmissions 215 are associated with a first SCS (e.g., 30 kHz) that is greater (e.g., higher) than a second SCS (e.g., 15 kHz) associated with LTE sidelink receptions 220. In other words, techniques described herein may enable the UE 115-a to select (e.g., at a MAC layer) at least an NR slot 210-a overlapping with an LTE subframe 205 (or slot) and optionally an NR slot 210-b (e.g., subsequent NR slot 210) overlapping with the LTE subframe 205 for NR sidelink transmission 215 (e.g., for each transport block). In such cases, the UE 115-a may refrain from transmitting an NR sidelink transmission 215 via only an NR slot 210-b of an LTE subframe 205.

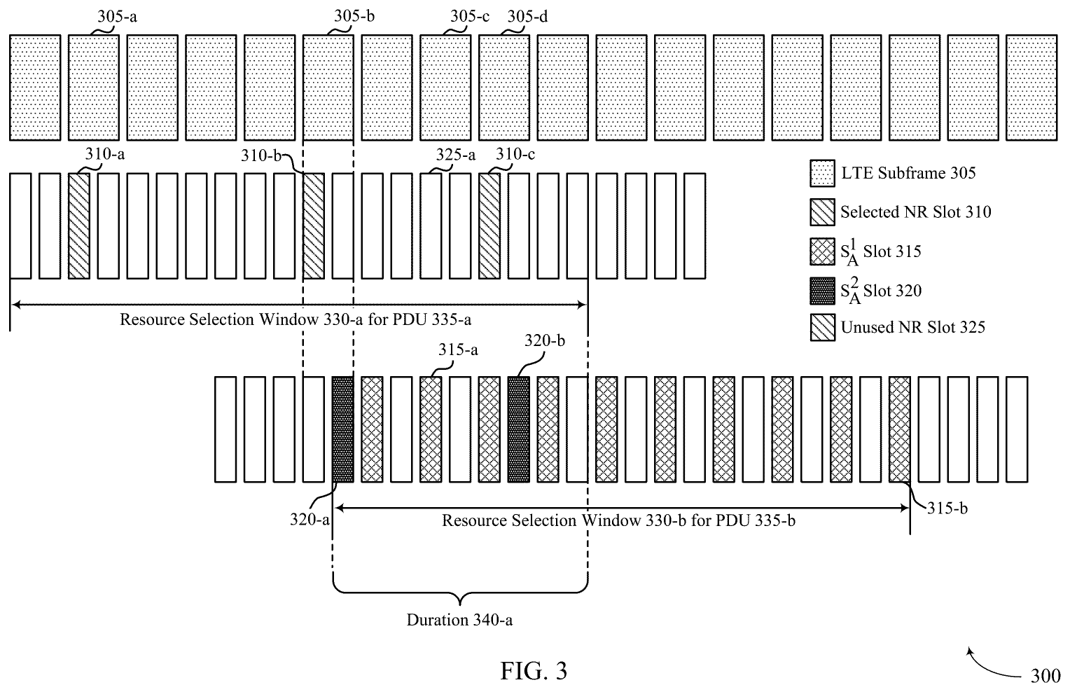

For example, the UE 115-a (e.g., MAC layer) may identify a first set of PDUs associated with a first resource selection window (e.g., transmission window), where the UE 115-a determine to transmit the first set of PDUs via one or more resources of the first resource selection window. Additionally, the UE 115-a (e.g., MAC layer) may identify (e.g., determine) one or more additional resource selection windows, such as a second resource selection window associated with a second set of PDUs, that at least partially overlaps with the first resource selection window. As such, the UE 115-a may determine a first set of available resources (e.g., transmission resources), where the first set of available resources includes NR slots 210-a (e.g., first overlapping NR slots 210), and a second set of available resources from the candidate resource set (e.g., S_{A}), where the second set of available resources includes NR slots 210-a (e.g., a first set of candidate resources S_{A}¹) and NR slots 210-b (e.g., a second set of candidate resource, S_{A}³) that are preceded by an NR slot 210-a scheduled for an NR sidelink transmission 215 associated with the first PDU. Thus, the UE 115-a may select one or more first resources (e.g., corresponding to one or more NR slots 210-a) from the first set of available resources for transmission of the first set of PDUs and one or more second resources (e.g., corresponding to one or more NR slots 210-a or one or more NR slots 210-a and one or more NR slots 210-b) from the second set of available resources for transmission of the second set of PDUs, as described further with reference to FIG. 3.

As used herein, including in the claims, the phrase “a set of PDUs,” including both a first set of PDUs and a second set of PDUs, may be understood to mean (e.g., may refer to) one or more PDUs.

Though described in the context of NR and LTE, this is not to be considered a limitation of the present disclosure. In this regard any combination of RATs may be considered with regards to the techniques described herein. Further, a same RAT with different SCSs may be considered with regards to the techniques described herein. Additionally, though described in the context of NR transmission 215 and LTE receptions 220, this is not to be regarded as a limitation of the present disclosure. In this regard, a combination of NR sidelink transmissions 215 and LTE sidelink transmissions, a combination of NR sidelink receptions and LTE sidelink transmissions, a combination of NR sidelink receptions and LTE sidelink receptions 220, or any combination of receptions and transmissions, may be considered with regards to the techniques described herein.

FIG. 3 shows an example of a resource selection scheme 300 that supports techniques for selecting resources for sidelink co-channel co-existence with mixed numerologies in accordance with one or more aspects of the present disclosure. In some cases, the resource selection scheme 300 may implement or be implemented by aspects of the wireless communications system 100, the wireless communications system 200, or both. For example, the resource selection scheme 300 may be implemented by one or more UEs 115 and one or more network entities 105, which may be examples of the corresponding devices as described herein.

FIG. 3 depicts a resource selection scheme 300 associated with overlapping LTE subframes 305 (or slots) and NR slots. In the context of FIG. 3, the first row depicts multiple LTE subframes 305, the second row depicts multiple NR slots, including selected NR slots 310 associated with transmission of a PDU 335-a, and the third row depict multiple NR slots, including S_{A}¹ slots 315 and S_{A}² slots 320 associated with transmission of a PDU 335-b. In such cases, the LTE subframes 305 of the first row, the NR slots of the second row, and the NR slots of the third row are associated with same time and frequency resources, but are shown as separate rows to enable depiction of how NR slots are chosen for transmissions of PDUs 335.

As described previously, techniques described herein may enable a UE 115 to select (e.g., at a MAC layer) at least a first NR slot 310 overlapping with an LTE subframe 305 (or subframe) and optionally a second NR slot 310 (e.g., subsequent NR slot 310) overlapping with the LTE subframe 305 for NR sidelink transmissions (e.g., for each transport block). For example, the MAC layer may determine, for the transmission of a PDU 335-a during a first resource selection window 330-a, a first set of transmission resources that correspond to a first set of NR slots (e.g., a first set of available NR slots) that each overlap with a first half of a respective LTE subframe 305 (e.g., LTE sidelink slot or subframe), where each LTE subframe 305 overlaps with a first NR slot (e.g., overlapping with the first half) and a second NR slot (e.g., overlapping with a second half). For example, a selected NR slot 310-a may be a first NR slot overlapping with a first half of an LTE subframe 305-a, a selected NR slot 310-b may be a first NR slot overlapping with a first half of an LTE subframe 305-b, an unused NR slot 325-a may be a first NR slot overlapping with a first half of an LTE subframe 305-c, and a selected NR slot 310-c may be a first NR slot overlapping with a first half of an LTE subframe 305-d. As such, the first set of NR slots may include the selected NR slot 310-a, the selected NR slot 310-b, the unused NR slot 325-a, the selected NR slot 310-c, and other first NR slots within the resource selection window 330-a. As such, the MAC layer may select one or more first transmission resources from the first set of transmission resources for transmission of the PDU 335-a via a sidelink connection. In the context of FIG. 3, the one or more first transmission resources may correspond to the selected NR slot 310-a, the selected NR slot 310-b, and the selected slot 310-c.

Additionally, the MAC layer may identify one or more additional NR sidelink transmissions associated with one or more different transport blocks whose associated resource selection window 330 overlaps with the resource selection window 330-a (e.g., a current resource selection window 330-a). For example, the UE 115 may identify the PDU 335-a (e.g., first set of NR PDUs) associated with the resource selection window 330-a at least partially overlaps (e.g., during a duration 340-a) with a PDU 335-b (e.g., second set of NR PDUs) associated with a resource selection window 330-b. Additionally, the MAC layer (e.g., higher layer) at the UE 115 may indicate (e.g., transmit, send), to a PHY layer (e.g., lower layer) at the UE 115, a first indication for the PHY layer to determine a candidate resource set (e.g., S_{A}), from a resource pool, associated with the resource selection window 330-a overlapping with the resource selection window 330-b (e.g., the overlapping duration 340-a). That is, the candidate resource set may include NR slots (e.g., in the third row) occurring in the resource selection window 330-a (e.g., S_{A}¹ slots 315, S_{A}² slots 320, and unused NR slots 325 in the resource selection window 330-b) and the resource pool may include the set of NR slots that occur within the resource selection window 330-b.

In some cases, the PHY layer may indicate, to the MAC layer (e.g., based on the first indication), a second indication of the candidate resource set (e.g., S_{A}) associated with the overlapping duration 340-a. In some cases, the second indication may further include, for each candidate resource of the candidate resource set, an indication of an NR slot (e.g., physical slot) that each candidate resource corresponds to. That is, the second indication may include a mapping of candidate resources to NR slots (e.g., a mapping of physical slot indices). As such, the MAC layer may determine, or identify, the resource selection window 330-b, in terms of NR slots, based on an earliest candidate resource (e.g., starting candidate resource) and a latest candidate resource (e.g., ending candidate resource) in a time domain (e.g., based on the second indication from the PHY layer). The earliest candidate resource may correspond to the S_{A}² slot 320-a and the ending latest candidate resource may correspond to the S_{A}¹ slot 315-b. Additionally, or alternatively, the second indication may further include an indication of a start and an end of the resource selection window 330-b. In other words, the second indication may further indicate the S_{A}² slot 320-a (e.g., a starting NR slot) and the S_{A}¹ slot 315-b (e.g., an ending NR slot) associated with the resource selection window 33-b. In such cases, the MAC layer may map NR slots (e.g., physical slots) to each of the candidate resources of the candidate resource set based on a logical slot configured (e.g., pre-configured) for the resource pool (e.g., transmit resource pool) via control signaling (e.g., RRC).

As such (e.g., for NR sidelink transmissions overlapping with the current resource selection window 330), the UE 115 may identify, or determine, a second set of transmission resources (e.g., including a first set of candidate resources S_{A}¹ and a second set of candidate resources S_{A}²) from the candidate resource set (e.g., S_{A}). In such cases, the second set of transmission resources may include a first subset of candidate resources (e.g., a first set of candidate resources S_{A}¹) that correspond to S_{A}¹ slots 315 that each overlap with a respective first half of a respective LTE subframe 305 (e.g., LTE sidelink slot or subframe). For example, the S_{A}¹ slot 310-a overlaps with a first half of the LTE subframe 305-a. Additionally, the second set of transmission resources may include a second subset of transmission resources (e.g., a second set of candidate resources S_{A}²) that correspond to S_{A}² NR slots 320 that each overlap with a second half of a respective LTE subframe 305 (e.g., are a latter NR slot overlapping with a respective LTE subframe 305) and are preceded (e.g., immediately), or are adjacent to, a selected NR slot 310 associated with a transmission scheduled for the PDU 335-a (e.g., preceded by a candidate resource from the first set of candidate resources). For example, the S_{A}² slots 320 may include a S_{A}² slot 320-a, preceded by the selected NR slot 310-b and a S_{A}² slot 320-b, preceded by the selected NR slot 310-c. Thus, the second set of transmission resources correspond to the S_{A}¹ slots 315 and the S_{A}² slots 320.

The UE 115 may select one or more second transmission resources from the second set of transmission resources (e.g., including the first subset and the second subset) to transmit the PDU 335-b during the resource selection window 330-b via the sidelink connection. In some cases, the MAC layer may select (e.g., randomly) the one or more second transmission resources from the first subset of transmission resources corresponding to the S_{A}¹ slots 315 (e.g., only select first NR slots 310 overlapping with an LTE subframe 305), which may result in inefficient resource utilization (e.g., lead to a loss of slots for NR). In some other cases, the MAC layer may select the one or more second transmission resources from a combination of the first subset of transmission resources, corresponding to the S_{A}¹ slots 315, and the second the first subset of transmission resources, corresponding to the S_{A}² slots 320 (e.g., S_{A}¹∪S_{A}²).

In some other cases, the MAC layer may select (e.g., randomly) the one or more second transmission resources from the first subset of transmission resources, corresponding to the S_{A}² slots 315, based on a percentage of transmission resources in the first subset of transmission resources relative to the candidate resource set exceeding (e.g., being greater than, satisfying) a threshold percentage. For example, the first subset of transmission resources may include 10 transmission resources and the candidate resource set may include 50 transmission resources, such that the percent of transmission resources in the first subset of transmission resources relative to the candidate resource set is 20%. Conversely, the MAC layer may select (e.g., randomly) the one or more second transmission resources from a combination of the first subset of transmission resources, corresponding to the S_{A}¹ slots 315, and the second subset of transmission resources, corresponding to the S_{A}² slots 320 based on the percentage of transmission resources in the first subset of transmission resources relative to the candidate resource set failing to exceed (e.g., being less than or equal to, failing to satisfy) the threshold percentage. Additionally, or alternatively, the MAC layer may select the one or more second transmission resources from any other combination of the first subset of transmission resources and the second subset of transmission resources.

Additionally, or alternatively, the MAC layer may select transmission resources (e.g., the one or more first transmission resources, the one or more second transmission resources, or both) based on transmission of HARQ feedback (e.g., when HARQ feedback is enabled). That is, the MAC layer may select successive transmission resources (e.g., for the one or more first transmission resources, the one or more second transmission resources, or both) based on a threshold duration (e.g., minimum time gap) associated with HARQ feedback reception and processing. That is, for example, the MAC layer may select a transmission resource corresponding to the S_{A}¹ slot 315-a and an additional transmission resource corresponding to the S_{A}² slot 320-b, for transmission of the PDU 335-b, such that a duration between the S_{A}¹ slot 315-a and the S_{A}² slot 320-b is greater than the threshold duration, such that HARQ feedback received in response to the S_{A}¹ slot 315-a may be received and processed (e.g., decoded) by the UE 115 prior to the S_{A}² slot 320-b.

In some cases, a transmission scheduled (e.g., determined to be transmitted) via a transmission resource that correspond to a first NR slot overlapping with a first half of an LTE subframe 305 may be canceled (e.g., due to re-evaluation or pre-emption). In such cases, a transmission scheduled via a transmission resource corresponding to a second NR slot of the LTE subframe 305 (e.g., adjacent to the first NR slot) may also be canceled. For example, a first transmission associated with the PDU 335-a may be scheduled during the selected NR slot 310-a and a second transmission associated with the PDU 335-b may be scheduled during the S_{A}² slot 320-a. As such, if the first transmission scheduled during the selected NR slot 310-b is canceled, the second transmission via the S_{A}² slot 320-a may degrade an LTE reception (e.g., or transmission) via the LTE subframe 305-b. As such, if the transmission scheduled via the selected NR slot 310-b is canceled, the transmission via the S_{A}² slot 320-a may also be canceled.

In some cases, the MAC layer may receive a cancelation indication (e.g., pre-emption and re-evaluation indication) that indicates cancelation of the transmission via the transmission resource corresponding to the selected NR slot 310-b and, in some cases, indicates the selected NR slot 310-b. In some examples, the second transmission canceled during the S_{A}² slot 320-a may be re-scheduled. That is, the transmission resource associated with the second transmission may be re-selected. In some cases, the re-selection may be based on a second threshold duration (e.g., if there is sufficient time). For example, the MAC layer may identify an additional transmission resource (e.g., from the second set of transmission resources) corresponding to the S_{A}¹ slot 315-a. As such, the MAC layer may reschedule the transmission to occur via the additional transmission resource corresponding to the S_{A}¹ slot 315-a based on a duration between the second transmission resource (e.g., the S_{A}¹ slot 315-a) and reception of the cancelation notification being greater than the second threshold duration. Otherwise, the UE 115 may drop the transmission initially scheduled via the second transmission resource.

Though described in the context of NR and LTE, this is not to be considered a limitation of the present disclosure. In this regard any combination of RATs may be considered with regards to the techniques described herein. Further, a same RAT with different SCSs may be considered with regards to the techniques described herein. Additionally, though described in the context of a PDU 335-a and a PDU 335-b, this is not to be regarded as a limitation of the present disclosure. In this regard, one or more PDUs 335-a (e.g., associated with the resources selection window 330-a) and one or more PDUs 335-b (e.g., associated with the resources selection window 330-b) may be considered with regards to the techniques described herein. As such, a set of PDUs as used herein may refer to one or more PDUs.

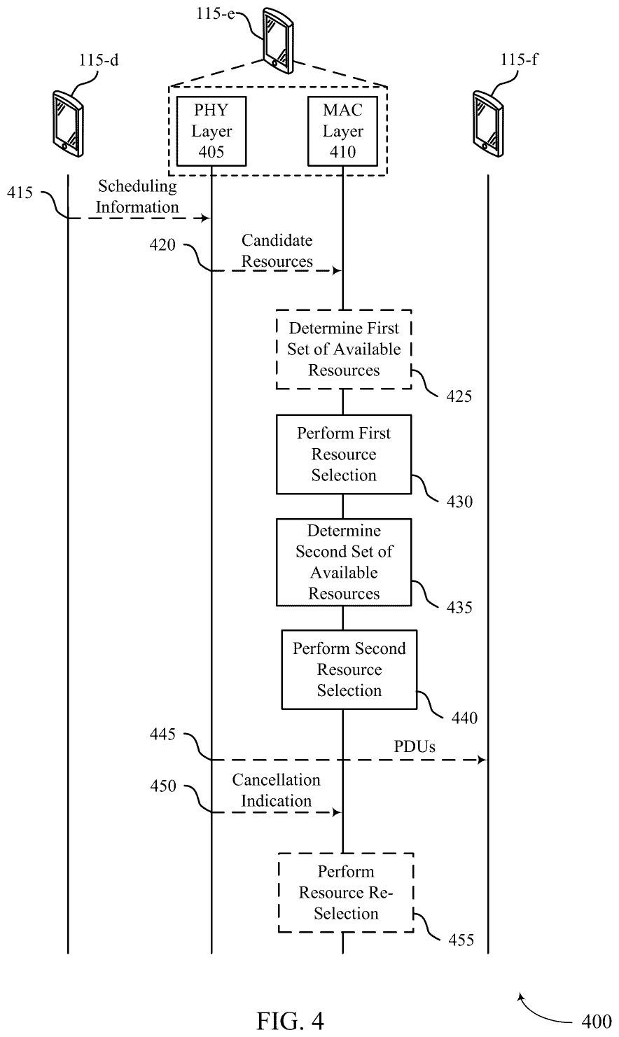

FIG. 4 shows an example of a process flow 400 that supports techniques for selecting resources for sidelink co-channel co-existence with mixed numerologies in accordance with one or more aspects of the present disclosure. In some cases, the process flow 400 may implement or be implemented by aspects of the wireless communications system 100, the wireless communications system 200, the resources selection scheme 300, or any combination thereof. For example, the process flow 400 may be implemented by one or more UEs 115 (e.g., a UE 115-d, a UE 115-e, and a UE 115-f) and one or more network entities 105, which may be examples of the corresponding devices as described herein.

In some cases, at 415, the UE 115-e (e.g., capable of supporting a first RAT and a second RAT) may receive, from the UE 115-d, scheduling information indicating a set of subframes for a second RAT (e.g., LTE). In such cases, each subframe of the set of subframes for the second RAT may overlap with a first slot, which may be referred to as a first overlapping slot, and a second slot, which may be referred to as a second overlapping slot, for a first RAT (e.g., NR), where the first slot precedes the second slot, based on the first RAT being associated with a higher SCS than the second RAT. That is, a first slot for the first RAT may overlap with a first half of a subframe for the second RAT and a second slot for the first RAT may overlap with a second half of the subframe for the second RAT. In some cases, the first RAT may be associated with an SCS of 30 kHz and the second RAT may be associated with an SCS of 15 kHz.

In some cases, at 420, a PHY layer 405 at the UE 115-e may indicate, to a MAC layer 410 at the UE 115-e, an indication of a third set of transmission resources (e.g., candidate resource set, S_{A}) and an indication of physical slot indices associated with each transmission resource of the third set of transmission resources. The third set of transmission resources may be based on a second resource selection window associated with a second set of PDUs at least partially overlapping with a first resource selection window associated with a first set of PDUs. In such cases, the second set of PDUs may be associated with a same or lower priority as the first set of PDUs, may be associated with a same cast-type as the first set of PDUs, may be associated with a same destination identifier as the first set of PDUs, or any combination thereof.

In some cases, the MAC layer 410 may determine a starting slot of the second resource selection window based on a starting transmission resource of the third set of transmission resources and the indicated physical slot indices, and may determine an end slot of the second resource selection window based at least in part on an ending transmission resource of the third set of transmission resources and the indicated physical slot indices. That is, the MAC layer 410 may map the starting transmission resource to a starting slot of the second resource selection window and the ending transmission resource to an ending slot of the second resource selection window based on the physical indices. In some other cases, the indication of the third set of transmission resources may further include an indication of the starting slot of the second resource selection window and the ending slot of the second resource selection window.

At 425, the MAC layer 410 may determine a first set of available transmission resources corresponding to a first set of available slots. In such cases, each transmission resource of the first set of available transmission resources may be aligned with a beginning of a respective subframe for the second RAT. That is, each transmission resource of the first set of available transmission resources may correspond to a respective first overlapping slot.

At 430, the MAC layer 410 may perform first resource selection associated with the first resource selection window to select one or more first transmission resources (e.g., corresponding to one or more first slots) from the first set of available transmission resources for transmitting the first set of PDUs via a first sidelink connection in accordance with the first RAT. In some cases, a duration between a first transmission resource of the one or more first transmission resources and an additional first transmission resource of the one or more first transmission resources may satisfy a first threshold duration, the first threshold duration associated with reception of feedback corresponding to transmission of the first set of PDUs via the first transmission resource.

At 435, the MAC layer 410 may determine a second set of available transmission resources, (e.g., a combination of a first set of candidate resources, S_{A}¹, and a second set of candidate resources, S_{A}²), corresponding to a second set of available slots, from the third set of available resources (e.g., candidate resource set, S_{A}). In such cases, the second set of available transmission resources may be based on the third set of transmission resources associated with the second resource selection window at least partially overlapping with the first resource selection window, each transmission resource of the second set of available transmission resources occurring in a latter portion of a respective subframe for the second RAT, and each transmission resource of the second set of available transmission resources being located with respect to a respective first transmission resource of the one or more first transmission resources.

In other words, the second set of available transmission resources may include a first subset of available transmission resources (e.g., the first set of candidate resources S_{A}¹) and a second subset of transmission resources (e.g., the second set of candidate resources S_{A}²). Each transmission resource of the first subset of available transmission resources may correspond to respective first overlapping slots. Additionally, each transmission resource of the second subset of available transmission resources may correspond to a respective second overlapping slot that is preceded by first overlapping slots corresponding to a transmission resource of the one or more transmission resources. That is, the respective second overlapping slot may be preceded (e.g., immediately) by a transmission associated with the first set of PDUs.

At 440, the MAC layer 410 may perform second resource selection to select one or more second transmission resources (e.g., corresponding to one or more second slots) for transmitting the second set of PDUs via the first sidelink connection in accordance with the first RAT. In some cases, a duration between a second transmission resource of the one or more second transmission resources and an additional second transmission resource of the one or more second transmission resources may satisfy the first threshold duration.

In some cases, the MAC layer 410 may select the one or more second transmission resources from the first subset of available transmission resources (e.g., the first set of candidate resources S_{A}¹). Alternatively, the MAC layer 410 may select the one or more second transmission resources from a combination of the first subset of available transmission resources and the second subset of available transmission resources (e.g., S_{A}¹∪S_{A}²).

In some cases, the MAC layer 410 may select the one or more second transmission resources from the second subset of available transmission resources (e.g., of the second set of available transmission resources) based on a percentage of transmission resources in the first subset of available transmission resources (e.g., the first set of candidate resources S_{A}¹) relative to the third set of transmission resources (e.g., candidate resource set, S_{A}) being less than a threshold percentage. That is, the MAC layer 410 may determine the first subset of available transmission resources from the third subset of transmission resources based on each transmission resource of the first subset of available transmission resources occurring in a respective slot that aligns with a beginning of a respective subframe for the second RAT (e.g., being a respective first overlapping slot). In some cases, a percentage of the transmission resources in the first subset of available transmission resources (e.g., the first set of candidate resources S_{A}¹) relative to the third set of transmission resources (e.g., candidate resource set, S_{A}) may be greater than a threshold percentage, such that the MAC layer 410 selects the one or more second transmission resources from the first subset of available transmission resources (e.g., the first set of candidate resources S_{A}¹). Alternatively, the percentage of the transmission resources in the first subset of available transmission resources (e.g., the first set of candidate resources S_{A}¹) relative to the third set of transmission resources (e.g., candidate resource set, S_{A}) may be less than or equal to a threshold percentage, such that the MAC layer 410 may select the one or more second transmission resources from a combination of the first subset of available transmission resources and the second subset of available transmission resources (e.g., S_{A}¹∪S_{A}²).

In some cases, at 445, the UE 115-e may transmit, via the first sidelink connection, the first set of PDUs via the one or more first transmission resources (e.g., corresponding one or more first slots) and the second set of PDUs via the one or more second transmission resources (e.g., corresponding one or more second slots).

In some other cases, at 450, the PHY layer 405 may indicate, to the MAC layer 410, a cancelation notification indicating a first transmission resource of the one or more transmission resources and indicating a first slot associated with the first transmission resource. In such cases, the first slot may be a first overlapping slot in a subframe for the second RAT. As such, the MAC layer 410 may cancel transmission of the first set of PDUs via the first slot based on receiving the cancelation notification. Additionally, the PHY layer may cancel transmission of the second set of PDUs via a second transmission resource of the one or more second transmission resources, where the second transmission resource corresponds to a second overlapping slot in the subframe for the second RAT, based on canceling transmission of the first set of PDUs via the first slot.

In some cases, at 455, the MAC layer 410 may perform resource re-selection to select an additional second transmission resource from the second set of available transmission resources for transmitting the second set of PDUs via the first sidelink connection in accordance with the first RAT based on canceling transmission of the second PDY via the second transmission resource of the one or more transmission resources. In such cases, the MAC layer 410 may perform the resource re-selection based on a second threshold duration between the second transmission resource and reception of the cancelation notification.

As described previously, as used herein, including in the claims, the phrase “a set of PDUs,” including both a first set of PDUs and a second set of PDUs, may be understood to mean (e.g., may refer to) one or more PDUs.

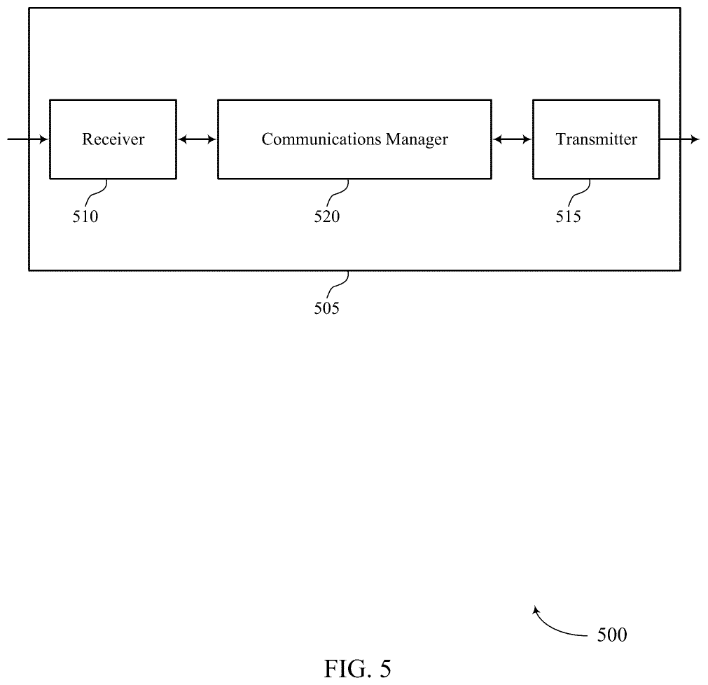

FIG. 5 shows a block diagram 500 of a device 505 that supports techniques for selecting resources for sidelink co-channel co-existence with mixed numerologies in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for selecting resources for sidelink co-channel co-existence with mixed numerologies). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for selecting resources for sidelink co-channel co-existence with mixed numerologies). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for selecting resources for sidelink co-channel co-existence with mixed numerologies as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for performing first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT. The communications manager 520 is capable of, configured to, or operable to support a means for determining a second set of available transmission resources for transmitting a second set of PDUs via the first sidelink connection in accordance with the first RAT based on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof. The communications manager 520 is capable of, configured to, or operable to support a means for performing second resource selection to select one or more second transmission resources from the second set of available transmission resources for transmitting the second set of PDUs via the first sidelink connection in accordance with the first RAT.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for selecting resources for sidelink transmissions of multiple set of PDUs in a co-channel co-existence scenario, which may result in processing, reduced power consumption, and more efficient utilization of communication resources, among other advantages.

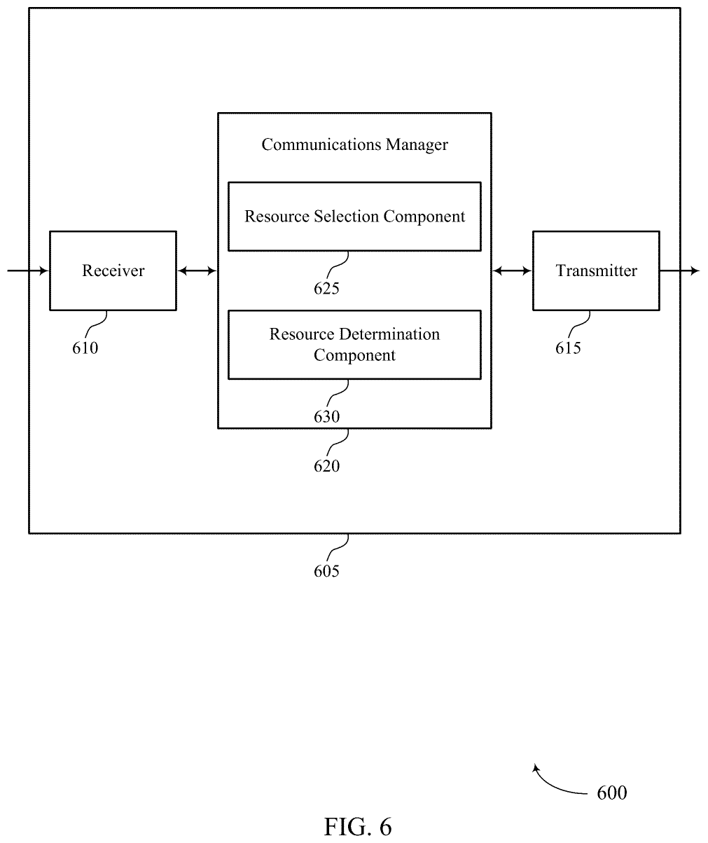

FIG. 6 shows a block diagram 600 of a device 605 that supports techniques for selecting resources for sidelink co-channel co-existence with mixed numerologies in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for selecting resources for sidelink co-channel co-existence with mixed numerologies). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for selecting resources for sidelink co-channel co-existence with mixed numerologies). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for selecting resources for sidelink co-channel co-existence with mixed numerologies as described herein. For example, the communications manager 620 may include a resource selection component 625 a resource determination component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The resource selection component 625 is capable of, configured to, or operable to support a means for performing first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT. The resource determination component 630 is capable of, configured to, or operable to support a means for determining a second set of available transmission resources for transmitting a second set of PDUs via the first sidelink connection in accordance with the first RAT based on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof. The resource selection component 625 is capable of, configured to, or operable to support a means for performing second resource selection to select one or more second transmission resources from the second set of available transmission resources for transmitting the second set of PDUs via the first sidelink connection in accordance with the first RAT.

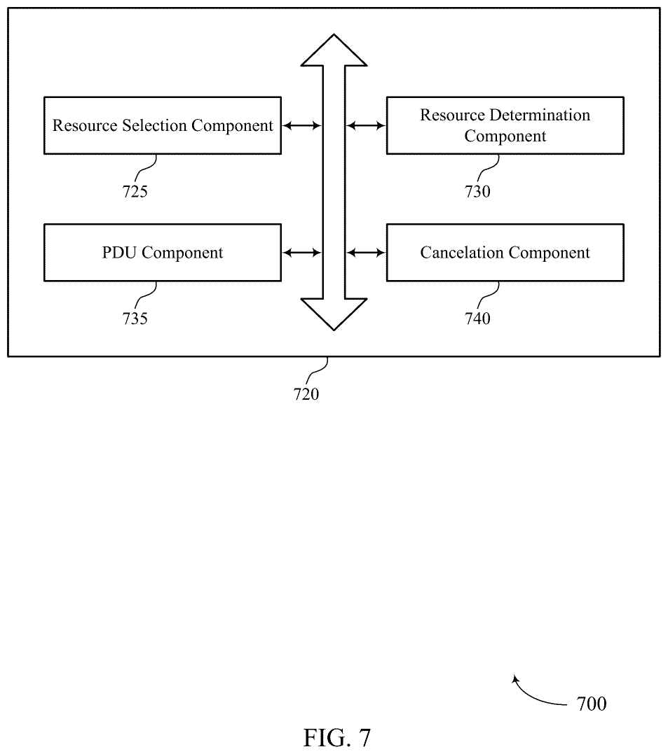

FIG. 7 shows a block diagram 700 of a communications manager 720 that supports techniques for selecting resources for sidelink co-channel co-existence with mixed numerologies in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for selecting resources for sidelink co-channel co-existence with mixed numerologies as described herein. For example, the communications manager 720 may include a resource selection component 725, a resource determination component 730, a set of PDUs component 735, a cancelation component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The resource selection component 725 is capable of, configured to, or operable to support a means for performing first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT. The resource determination component 730 is capable of, configured to, or operable to support a means for determining a second set of available transmission resources for transmitting a second set of PDUs via the first sidelink connection in accordance with the first RAT based on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof. In some examples, the resource selection component 725 is capable of, configured to, or operable to support a means for performing second resource selection to select one or more second transmission resources from the second set of available transmission resources for transmitting the second set of PDUs via the first sidelink connection in accordance with the first RAT.

In some examples, to support determining the second set of available transmission resources, the resource determination component 730 is capable of, configured to, or operable to support a means for determining a first subset of transmission resources from the third set of transmission resources based on each transmission resource of the first subset of transmission resources occurring in a respective slot that aligns with a beginning of a respective subframe for the second RAT. In some examples, to support determining the second set of available transmission resources, the resource determination component 730 is capable of, configured to, or operable to support a means for determining a second subset of transmission resources from the third set of transmission resources based on each transmission resource of the second subset of transmission resources being located with respect to a respective first transmission resource of the one or more first transmission resources, where the one or more second transmission resources are selected from the second subset of transmission resources based on a percentage of transmission resources in the first subset of transmission resources being less than a threshold percentage of resources that are available in the third set of transmission resources.

In some examples, the resource determination component 730 is capable of, configured to, or operable to support a means for receiving, from a lower layer, an indication of the third set of transmission resources and an indication of physical slot indices associated with each transmission resource of the third set of transmission resources.

In some examples, the resource determination component 730 is capable of, configured to, or operable to support a means for determining a starting slot of the second resource selection window based on a starting transmission resource of the third set of transmission resources and the indicated physical slot indices. In some examples, the resource determination component 730 is capable of, configured to, or operable to support a means for determining an end slot of the second resource selection window based on an ending transmission resource of the third set of transmission resources and the indicated physical slot indices.

In some examples, the indication further includes an indication of a starting slot of the second resource selection window and an ending slot of the second resource selection window.

In some examples, the set of PDUs component 735 is capable of, configured to, or operable to support a means for transmitting, via the first sidelink connection, the first set of PDUs via the one or more first transmission resources and the second set of PDUs via the one or more second transmission resources.

In some examples, a first transmission resource of the one or more first transmission resources corresponds to a first slot for the first RAT that overlaps with a subframe for the second RAT and a second transmission resource of the one or more second transmission resources corresponds to a second slot for the first RAT that overlaps with the latter portion of the subframe, and the cancelation component 740 is capable of, configured to, or operable to support a means for canceling transmission of the second set of PDUs via the second slot based on canceling transmission of the first set of PDUs via the first slot.

In some examples, the cancelation component 740 is capable of, configured to, or operable to support a means for receiving a cancelation notification indicating the first transmission resource associated and indicating the first slot associated with the first transmission resource. In some examples, the cancelation component 740 is capable of, configured to, or operable to support a means for canceling the transmission of the first set of PDUs via the first slot based on receiving the cancelation notification.

In some examples, the resource selection component 725 is capable of, configured to, or operable to support a means for performing resource re-selection to select an additional second transmission resource of the one or more second transmission resources for transmitting the second set of PDUs via the first sidelink connection in accordance with the first RAT based on canceling transmission of the second set of PDUs via the second transmission resource of the one or more second transmission resources.

In some examples, the resource re-selection is performed based on a threshold duration between the second transmission resource and reception of a cancelation notification.

In some examples, a duration between a first transmission resource of the one or more first transmission resources and an additional transmission resource of the one or more first transmission resources satisfies a threshold duration, the threshold duration associated with reception of feedback corresponding to transmission of the first set of PDUs via the first transmission resource.

In some examples, the second set of PDUs is associated with a same priority or a lower priority as the first set of PDUs, is associated with a same cast-type as the first set of PDUs, is associated with a same destination identifier as the first set of PDUs, or any combination thereof.

In some examples, the first RAT is a NR RAT and the second RAT is LTE RAT.

In some examples, a SCS of the first RAT is 30 kilohertz and a SCS of the second RAT is 15 kilohertz.

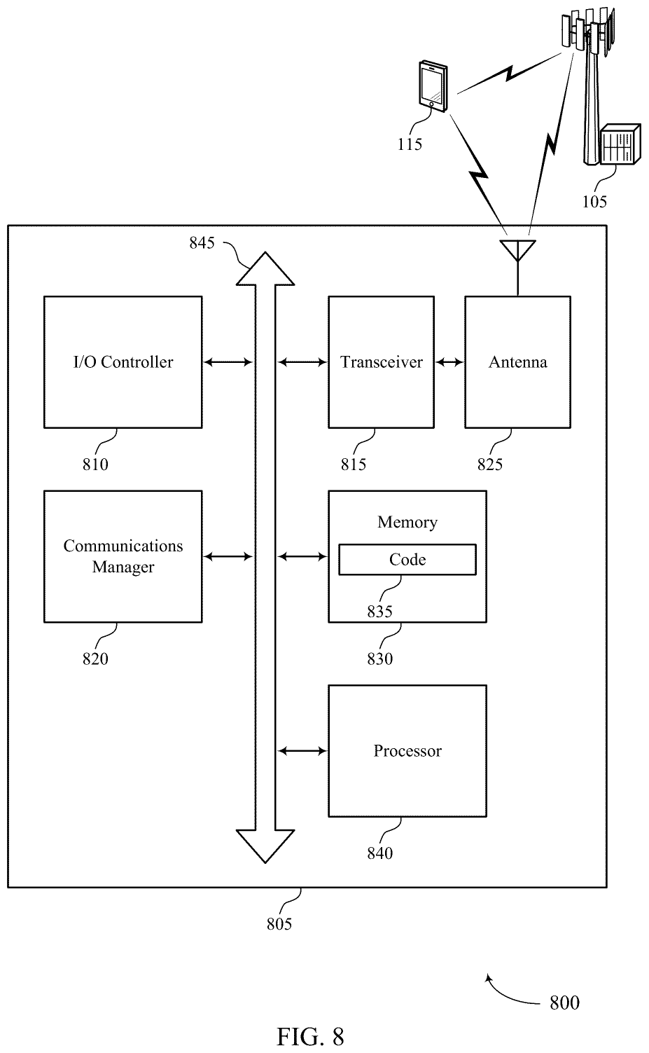

FIG. 8 shows a diagram of a system 800 including a device 805 that supports techniques for selecting resources for sidelink co-channel co-existence with mixed numerologies in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for selecting resources for sidelink co-channel co-existence with mixed numerologies). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for performing first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT. The communications manager 820 is capable of, configured to, or operable to support a means for determining a second set of available transmission resources for transmitting a second set of PDUs via the first sidelink connection in accordance with the first RAT based on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof. The communications manager 820 is capable of, configured to, or operable to support a means for performing second resource selection to select one or more second transmission resources from the second set of available transmission resources for transmitting the second set of PDUs via the first sidelink connection in accordance with the first RAT.

By including or configuring the communications manager 820 in accordance with examples as described herein, the device 805 may support techniques for selecting resources for sidelink transmissions of multiple set of PDUs in a co-channel co-existence scenario, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for selecting resources for sidelink co-channel co-existence with mixed numerologies as described herein, or the at least one processor 840 and the at least one memory 830 may be otherwise configured to, individually or collectively, perform or support such operations.

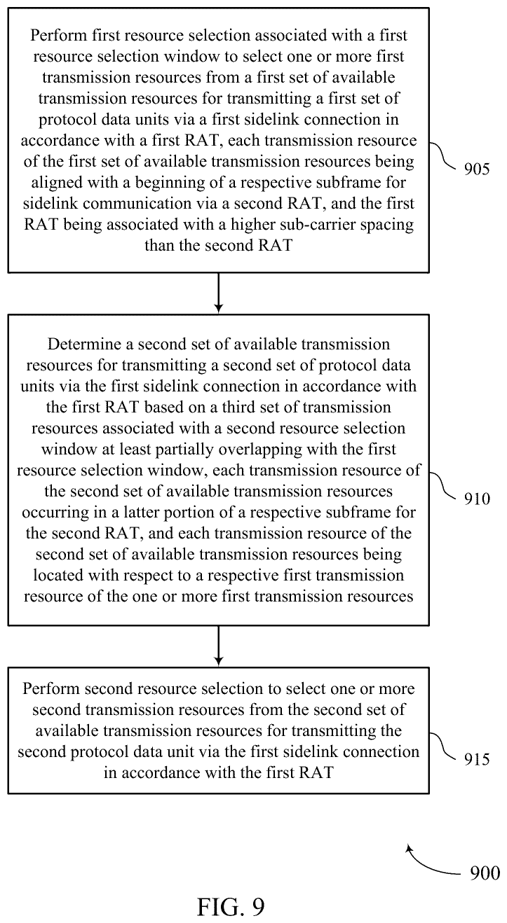

FIG. 9 shows a flowchart illustrating a method 900 that supports techniques for selecting resources for sidelink co-channel co-existence with mixed numerologies in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include performing first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT. The operations of block 905 may be performed in accordance with examples as disclosed herein. In some examples, aspects of the operations of 905 may be performed by a resource selection component 725 as described with reference to FIG. 7.

At 910, the method may include determining a second set of available transmission resources for transmitting a second set of PDUs via the first sidelink connection in accordance with the first RAT based on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof. The operations of block 910 may be performed in accordance with examples as disclosed herein. In some examples, aspects of the operations of 910 may be performed by a resource determination component 730 as described with reference to FIG. 7.

At 915, the method may include performing second resource selection to select one or more second transmission resources from the second set of available transmission resources for transmitting the second set of PDUs via the first sidelink connection in accordance with the first RAT. The operations of block 915 may be performed in accordance with examples as disclosed herein. In some examples, aspects of the operations of 915 may be performed by a resource selection component 725 as described with reference to FIG. 7.

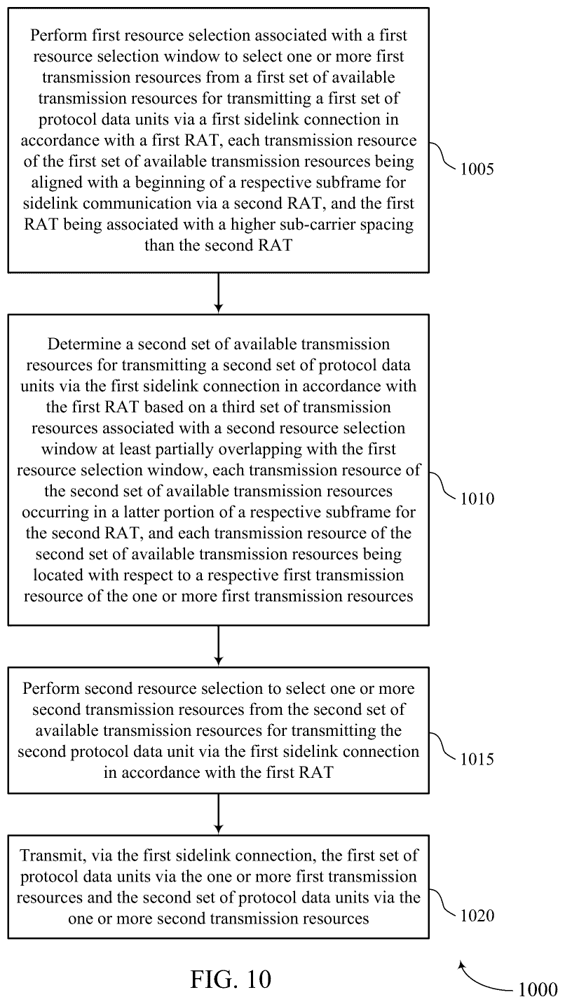

FIG. 10 shows a flowchart illustrating a method 1000 that supports techniques for selecting resources for sidelink co-channel co-existence with mixed numerologies in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include performing first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT. The operations of block 1005 may be performed in accordance with examples as disclosed herein. In some examples, aspects of the operations of 1005 may be performed by a resource selection component 725 as described with reference to FIG. 7.

At 1010, the method may include determining a second set of available transmission resources for transmitting a second set of PDUs via the first sidelink connection in accordance with the first RAT based on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof. The operations of block 1010 may be performed in accordance with examples as disclosed herein. In some examples, aspects of the operations of 1010 may be performed by a resource determination component 730 as described with reference to FIG. 7.

At 1015, the method may include performing second resource selection to select one or more second transmission resources from the second set of available transmission resources for transmitting the second set of PDUs via the first sidelink connection in accordance with the first RAT. The operations of block 1015 may be performed in accordance with examples as disclosed herein. In some examples, aspects of the operations of 1015 may be performed by a resource selection component 725 as described with reference to FIG. 7.

At 1020, the method may include transmitting, via the first sidelink connection, the first set of PDUs via the one or more first transmission resources and the second set of PDUs via the one or more second transmission resources. The operations of block 1020 may be performed in accordance with examples as disclosed herein. In some examples, aspects of the operations of 1020 may be performed by a set of PDUs component 735 as described with reference to FIG. 7.

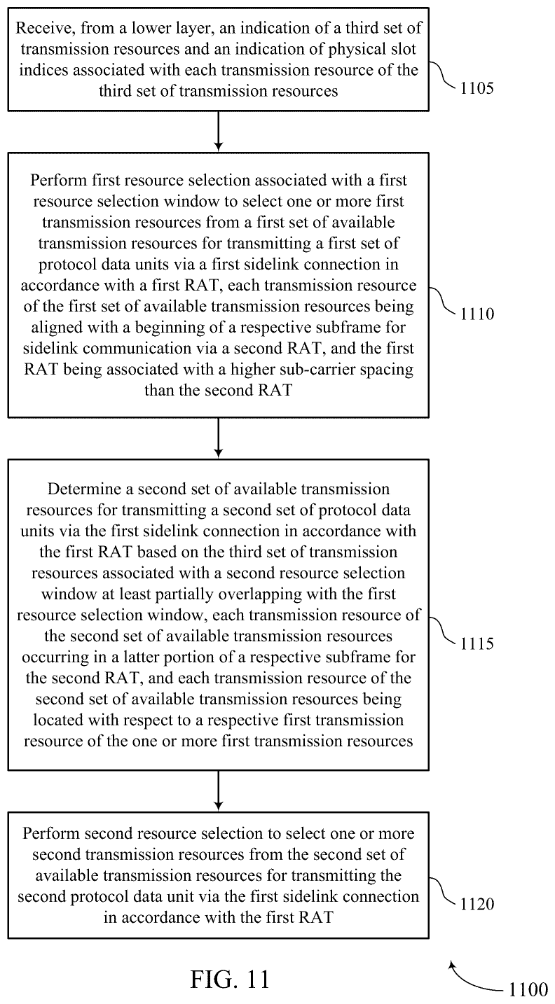

FIG. 11 shows a flowchart illustrating a method 1100 that supports techniques for selecting resources for sidelink co-channel co-existence with mixed numerologies in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving, from a lower layer, an indication of a third set of transmission resources and an indication of physical slot indices associated with each transmission resource of the third set of transmission resources. The operations of block 1105 may be performed in accordance with examples as disclosed herein. In some examples, aspects of the operations of 1105 may be performed by a resource determination component 730 as described with reference to FIG. 7.

At 1110, the method may include performing first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT. The operations of block 1110 may be performed in accordance with examples as disclosed herein. In some examples, aspects of the operations of 1110 may be performed by a resource selection component 725 as described with reference to FIG. 7.

At 1115, the method may include determining a second set of available transmission resources for transmitting a second set of PDUs via the first sidelink connection in accordance with the first RAT based on the third set of transmission resources associated with a second resource selection window at least partially overlapping with the first resource selection window, each transmission resource of the second set of available transmission resources occurring in a latter portion of a respective subframe for the second RAT, and each transmission resource of the second set of available transmission resources being located with respect to a respective first transmission resource of the one or more first transmission resources. The operations of block 1115 may be performed in accordance with examples as disclosed herein. In some examples, aspects of the operations of 1115 may be performed by a resource determination component 730 as described with reference to FIG. 7.

At 1120, the method may include performing second resource selection to select one or more second transmission resources from the second set of available transmission resources for transmitting the second set of PDUs via the first sidelink connection in accordance with the first RAT. The operations of block 1120 may be performed in accordance with examples as disclosed herein. In some examples, aspects of the operations of 1120 may be performed by a resource selection component 725 as described with reference to FIG. 7.

The following provides an overview of aspects of the present disclosure:

Aspect 1: A method for wireless communications at a UE, comprising: performing first resource selection associated with a first resource selection window to select one or more first transmission resources from a first set of available transmission resources for transmitting a first set of PDUs via a first sidelink connection in accordance with a first RAT, each transmission resource of the first set of available transmission resources being aligned with a beginning of a respective subframe for sidelink communication via a second RAT, and the first RAT being associated with a higher SCS than the second RAT; determining a second set of available transmission resources for transmitting a second set of PDUs via the first sidelink connection in accordance with the first RAT based at least in part on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof; and performing second resource selection to select one or more second transmission resources from the second set of available transmission resources for transmitting the second set of PDUs via the first sidelink connection in accordance with the first RAT.

Aspect 2: The method of aspect 1, wherein determining the second set of available transmission resources comprises: determining a first subset of transmission resources from the third set of transmission resources based at least in part on each transmission resource of the first subset of transmission resources occurring in a respective slot that aligns with a beginning of a respective subframe for the second RAT; and determining a second subset of transmission resources from the third set of transmission resources based at least in part on each transmission resource of the second subset of transmission resources being located with respect to a respective first transmission resource of the one or more first transmission resources, wherein the one or more second transmission resources are selected from the second subset of transmission resources based at least in part on a percentage of transmission resources in the first subset of transmission resources being less than a threshold percentage of resources that are available in the third set of transmission resources.

Aspect 3: The method of any of aspects 1 through 2, further comprising: receiving, from a lower layer, an indication of the third set of transmission resources and an indication of physical slot indices associated with each transmission resource of the third set of transmission resources.

Aspect 4: The method of aspect 3, further comprising: determining a starting slot of the second resource selection window based at least in part on a starting transmission resource of the third set of transmission resources and the indicated physical slot indices; and determining an end slot of the second resource selection window based at least in part on an ending transmission resource of the third set of transmission resources and the indicated physical slot indices.

Aspect 5: The method of any of aspects 3 through 4, wherein the indication further comprises an indication of a starting slot of the second resource selection window and an ending slot of the second resource selection window.

Aspect 6: The method of any of aspects 1 through 5, further comprising: transmitting, via the first sidelink connection, the first set of PDUs via the one or more first transmission resources and the second set of PDUs via the one or more second transmission resources.

Aspect 7: The method of any of aspects 1 through 6, wherein a first transmission resource of the one or more first transmission resources corresponds to a first slot for the first RAT that overlaps with a subframe for the second RAT and a second transmission resource of the one or more second transmission resources corresponds to a second slot for the first RAT that overlaps with the latter portion of the subframe, the method further comprising: canceling transmission of the second set of PDUs via the second slot based at least in part on canceling transmission of the first set of PDUs via the first slot.

Aspect 8: The method of aspect 7, further comprising: receiving a cancelation notification indicating the first transmission resource associated and indicating the first slot associated with the first transmission resource; and canceling the transmission of the first set of PDUs via the first slot based at least in part on receiving the cancelation notification.

Aspect 9: The method of any of aspects 7 through 8, further comprising: performing resource re-selection to select an additional second transmission resource of the one or more second transmission resources for transmitting the second set of PDUs via the first sidelink connection in accordance with the first RAT based at least in part on canceling transmission of the second set of PDUs via the second transmission resource of the one or more second transmission resources.

Aspect 10: The method of aspect 9, wherein the resource re-selection is performed based at least in part on a threshold duration between the second transmission resource and reception of a cancelation notification.

Aspect 11: The method of any of aspects 1 through 10, wherein a duration between a first transmission resource of the one or more first transmission resources and an additional transmission resource of the one or more first transmission resources satisfies a threshold duration, the threshold duration associated with reception of feedback corresponding to transmission of the first set of PDUs via the first transmission resource.

Aspect 12: The method of any of aspects 1 through 11, wherein the second set of PDUs is associated with a same priority or a lower priority as the first set of PDUs, is associated with a same cast-type as the first set of PDUs, is associated with a same destination identifier as the first set of PDUs, or any combination thereof.

Aspect 13: The method of any of aspects 1 through 12, wherein the first RAT is a NR RAT and the second RAT is LTE RAT.

Aspect 14: The method of any of aspects 1 through 13, wherein a SCS of the first RAT is 30 kHz and a SCS of the second RAT is 15 kHz.

Aspect 15: A UE for wireless communications, comprising one or more memories storing processor-executable code, and one or more processors coupled with the one or more memories and individually or collectively operable to execute the code to cause the UE to perform a method of any of aspects 1 through 14.

Aspect 16: A UE for wireless communications, comprising at least one means for performing a method of any of aspects 1 through 14.

Aspect 17: A non-transitory computer-readable medium storing code for wireless communications, the code comprising instructions executable by a processor to perform a method of any of aspects 1 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
perform first resource selection associated with a first resource selection window to select one or more first transmission resources from a first set of available transmission resources for transmitting a first set of protocol data units via a first sidelink connection in accordance with a first radio access technology (RAT), each transmission resource of the first set of available transmission resources being aligned with a beginning of a respective subframe for sidelink communication via a second RAT, and the first RAT being associated with a higher sub-carrier spacing than the second RAT;
determine a second set of available transmission resources for transmitting a second set of protocol data units via the first sidelink connection in accordance with the first RAT based at least in part on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof; and
perform second resource selection to select one or more second transmission resources from the second set of available transmission resources for transmitting the second set of protocol data units via the first sidelink connection in accordance with the first RAT.

2. The UE of claim 1, wherein, to determine the second set of available transmission resources, the one or more processors are individually or collectively operable to execute the code to cause the UE to:
determine a first subset of transmission resources from the third set of transmission resources based at least in part on each transmission resource of the first subset of transmission resources occurring in a respective slot that aligns with a beginning of a respective subframe for the second RAT; and
determine a second subset of transmission resources from the third set of transmission resources based at least in part on each transmission resource of the second subset of transmission resources being located with respect to a respective first transmission resource of the one or more first transmission resources, wherein the one or more second transmission resources are selected from the second subset of transmission resources based at least in part on a percentage of transmission resources in the first subset of transmission resources being less than a threshold percentage of resources that are available in the third set of transmission resources.

3. The UE of claim 1, wherein the one or more processors are individually or collectively further operable to execute the code to cause the UE to:
receive, from a lower layer, an indication of the third set of transmission resources and an indication of physical slot indices associated with each transmission resource of the third set of transmission resources.

4. The UE of claim 3, wherein the one or more processors are individually or collectively further operable to execute the code to cause the UE to:
determine a starting slot of the second resource selection window based at least in part on a starting transmission resource of the third set of transmission resources and the indicated physical slot indices; and
determine an end slot of the second resource selection window based at least in part on an ending transmission resource of the third set of transmission resources and the indicated physical slot indices.

5. The UE of claim 3, wherein the indication further comprises an indication of a starting slot of the second resource selection window and an ending slot of the second resource selection window.

6. The UE of claim 1, wherein the one or more processors are individually or collectively further operable to execute the code to cause the UE to:
transmit, via the first sidelink connection, the first set of protocol data units via the one or more first transmission resources and the second set of protocol data units via the one or more second transmission resources.

7. The UE of claim 1, wherein a first transmission resource of the one or more first transmission resources corresponds to a first slot for the first RAT that overlaps with a subframe for the second RAT and a second transmission resource of the one or more second transmission resources corresponds to a second slot for the first RAT that overlaps with the latter portion of the subframe, and the one or more processors are individually or collectively further operable to execute the code to cause the UE to:
cancel transmission of the second set of protocol data units via the second slot based at least in part on canceling transmission of the first set of protocol data units via the first slot.

8. The UE of claim 7, wherein the one or more processors are individually or collectively further operable to execute the code to cause the UE to:
receive a cancelation notification indicating the first transmission resource associated and indicating the first slot associated with the first transmission resource; and
cancel the transmission of the first set of protocol data units via the first slot based at least in part on receiving the cancelation notification.

9. The UE of claim 7, wherein the one or more processors are individually or collectively further operable to execute the code to cause the UE to:
perform resource re-selection to select an additional second transmission resource of the one or more second transmission resources for transmitting the second set of protocol data units via the first sidelink connection in accordance with the first RAT based at least in part on canceling transmission of the second set of protocol data units via the second transmission resource of the one or more second transmission resources.

10. The UE of claim 9, wherein the resource re-selection is performed based at least in part on a threshold duration between the second transmission resource and reception of a cancelation notification.

11. The UE of claim 1, wherein a duration between a first transmission resource of the one or more first transmission resources and an additional transmission resource of the one or more first transmission resources satisfies a threshold duration, the threshold duration associated with reception of feedback corresponding to transmission of the first set of protocol data units via the first transmission resource.

12. The UE of claim 1, wherein the second set of protocol data units is associated with a same priority or a lower priority as the first set of protocol data units, is associated with a same cast-type as the first set of protocol data units, is associated with a same destination identifier as the first set of protocol data units, or any combination thereof.

13. The UE of claim 1, wherein the first RAT is a New Radio (NR) RAT and the second RAT is Long Term Evolution (LTE) RAT.

14. The UE of claim 1, wherein a sub-carrier spacing of the first RAT is 30 kilohertz and a sub-carrier spacing of the second RAT is 15 kilohertz.

15. A method for wireless communications at a user equipment (UE), comprising:
performing first resource selection associated with a first resource selection window to select one or more first transmission resources from a first set of available transmission resources for transmitting a first set of protocol data units via a first sidelink connection in accordance with a first radio access technology (RAT), each transmission resource of the first set of available transmission resources being aligned with a beginning of a respective subframe for sidelink communication via a second RAT, and the first RAT being associated with a higher sub-carrier spacing than the second RAT;
determining a second set of available transmission resources for transmitting a second set of protocol data units via the first sidelink connection in accordance with the first RAT based at least in part on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof; and
performing second resource selection to select one or more second transmission resources from the second set of available transmission resources for transmitting the second set of protocol data units via the first sidelink connection in accordance with the first RAT.

16. The method of claim 15, wherein determining the second set of available transmission resources comprises:
determining a first subset of transmission resources from the third set of transmission resources based at least in part on each transmission resource of the first subset of transmission resources occurring in a respective slot that aligns with a beginning of a respective subframe for the second RAT; and
determining a second subset of transmission resources from the third set of transmission resources based at least in part on each transmission resource of the second subset of transmission resources being located with respect to a respective first transmission resource of the one or more first transmission resources, wherein the one or more second transmission resources are selected from the second subset of transmission resources based at least in part on a percentage of transmission resources in the first subset of transmission resources being less than a threshold percentage of resources that are available in the third set of transmission resources.

17. The method of claim 15, further comprising:
receiving, from a lower layer, an indication of the third set of transmission resources and an indication of physical slot indices associated with each transmission resource of the third set of transmission resources.

18. The method of claim 17, further comprising:
determining a starting slot of the second resource selection window based at least in part on a starting transmission resource of the third set of transmission resources and the indicated physical slot indices; and
determining an end slot of the second resource selection window based at least in part on an ending transmission resource of the third set of transmission resources and the indicated physical slot indices.

19. The method of claim 17, wherein the indication further comprises an indication of a starting slot of the second resource selection window and an ending slot of the second resource selection window.

20. A non-transitory computer-readable medium storing code for wireless communications, the code comprising instructions executable by one or more processors to:
perform first resource selection associated with a first resource selection window to select one or more first transmission resources from a first set of available transmission resources for transmitting a first set of protocol data units via a first sidelink connection in accordance with a first radio access technology (RAT), each transmission resource of the first set of available transmission resources being aligned with a beginning of a respective subframe for sidelink communication via a second RAT, and the first RAT being associated with a higher sub-carrier spacing than the second RAT;
determine a second set of available transmission resources for transmitting a second set of protocol data units via the first sidelink connection in accordance with the first RAT based at least in part on a third set of transmission resources associated with a second resource selection window at least partially overlapping with the first resource selection window, each transmission resource of the second set of available transmission resources occurring in a latter portion of a respective subframe for the second RAT, each transmission resource of the second set of available transmission resources being located with respect to a respective first transmission resource of the one or more first transmission resources, or any combination thereof; and
perform second resource selection to select one or more second transmission resources from the second set of available transmission resources for transmitting the second set of protocol data units via the first sidelink connection in accordance with the first RAT.
